(19) United States
(12) Patent Application Publication
(10) Pub. No.: US 2006/0233377 A1
(43) Pub. Date: Oct. 19, 2006

(54) Key distribution method of mobile ad hoc network

(76) Inventors: Hwang-Daw Chang, Taoyuan (TW); Chih-Liang Tsao, Taoyuan (TW); Chin-Chuan Li, Taoyuan (TW)

Correspondence Address: J.C. Patents, Inc., Suite 250, 4 Venture, Irvine, CA, 92618, US

(21) Appl. No.: 11/096,958

(22) Filed: Mar. 31, 2005

(51) Int. Cl. H04L 9/00

(52) U.S. Cl. 380/278

(57) ABSTRACT

A key distribution method is provided. The method is adapted for a network. The network comprises a plurality of nodes. In the key distribution method, a plurality of keys are provided to each node. A plurality of blocks are provided, serving as platforms. An algorithmic parameter is selected and a plurality of key parameters are provided to establish a balanced incomplete block (BIB) design area. One of the nodes broadcasts key parameters. The method can reduce the number of the key transmission, fast establish common keys, and reduce the network bandwidth for distributing the keys.

### BACKGROUND OF THE INVENTION

1. Field of the Invention

The present invention relates to a key distribution method, and more particularly to a key distribution method of a mobile ad hoc network by generating common keys with a balanced incomplete block (BIB).

2. Description of the Related Art

FIG. 1 is a schematic drawing showing a prior art symmetric encryption system. In a symmetric key cryptosystem 100, plain texts are input from the sender in the operation 102. The plain texts are then encrypted with a secret key shared by the sender and the receiver in the encryption operation 104. The encrypted texts are then transmitted to the receiver. The receiver then uses the secret key to decrypt the secreted texts in the decryption operation 106, and to output the plain text in the operation 108. Accordingly, the receiver and the sender must share the same set of the common key.

In the prior art technology, the symmetric key cryptosystem is generally used in encrypting/decrypting data to prevent eavesdropping by a third party. In the symmetric key cryptosystem, the key distribution is required. Through a secured channel, the sender and receiver share the same set of the common key.

There are two main key distribution methods. One is the central key distribution method as shown in FIG. 2. In this method, the key distribution center (KDC) 202 transmits the key to the main frames A204, B 206 and C208. Another method is the non-central key distribution method as shown in FIG. 3. In this method, the keys are transmitted among the main frames A204, B 206 and C208. In the non-central key distribution method of the prior art technology, if there are many main frames and the network is a mobile ad hoc network, the key distribution method becomes complicate, time-consuming, and non-efficient.

In the modern network development, the mobile ad hoc network (MANET) is a wireless network communication system without infrastructure. In the MANET, a central control mechanism is not required, and the bandwidth is shared by mobile nodes. Each node is a host as well as a router. Under the routing protocol, data can be transmitted to the receiver by the multihop method. Due to its limited bandwidth and without the central control mechanism, the security system for the mobile ad hoc network is more complicate and difficult to be established. The present invention provides a fast and efficient common key distribution method to solve the problems confronted in the key distribution method of the security system of the mobile ad hoc network.

FIG. 4 is a drawing showing a prior art mobile ad hoc network. There are mobile nodes MH1-MH8. Each mobile node individually and independently moves. By the cooperation of the mobile nodes, the data can be transmitted to the destination by the multihop method. For example, in the data transmission from the mobile node MH1 to the mobile node MH5, the data cannot be directly transmitted from the mobile node MH1 to the mobile node MH5. The data, therefore, must be transmitted from the mobile node MH1 to the mobile node MH2, from the mobile node MH2 to the mobile node MH4, from the mobile node MH4 to the mobile node MH6, from the mobile node MH6 to the mobile node MH5, and to the destination.

In the key distribution, a key distribution center is used to distribute the keys to the network users. With no infrastructure and dynamic nodes, the mobile ad hoc network is not suitable to establish a key distribution center. In a non-central key distribution protocol, MANET users must exchange keys through itself. For example, In a MANET with N mobile nodes, the key must be transmitted for N*(N−1)/2 times, the secured link of the network can be established. In the example with 100 nodes, the key must be transmitted for 4950 times, 100*(100−1)/2=4950. Accordingly, how to reduce the number of the transmission with the limited bandwidth in the mobile ad hoc network becomes essential.

In addition, the bandwidth of the mobile ad hoc network is a precious and limited resource. In the non-central key distribution protocol of the security system, the key must be transmitted for N*(N−1)/2 times to establish the secured link of the network.

Referring to FIG. 5, the MANET comprises 8 mobile nodes MH1-MH8. When the node MH1 want secretly communicates with other nodes, their common key must be established. Accordingly, the node MH1 must transmit the key with the nodes MH2-MH8. The key must be distributed for 7 times, so the secured link of the network between the node MH1 and the other nodes can be established. It will take 7*8/2=28 times of key distribution between the nodes to establish the whole network. Each key distribution requires several hops. The key distribution is slow and consumes a substantial part of the bandwidth. As a result, the key distribution will cause impact to the data transmission in the mobile ad hoc network.

### SUMMARY OF THE INVENTION

Accordingly, the present invention is directed to a key distribution method. The xor operation with the balanced incomplete block (BIB) is executed for the common key channels to generate the common keys.

The present invention is also directed to a key distribution. The common key channels are connected with the BIB to generate the common keys.

The present invention provides a key distribution method. The method is adapted for a network. The network comprises a plurality of nodes. In the key distribution method, a plurality of keys are provided to each of the nodes. A plurality of blocks are provided as platforms of the nodes. An algorithmic parameter is selected, and a plurality of key parameters are provided to establish a balanced incomplete block (BIB) design area. The key parameters are broadcasted from one of the nodes. Each of the nodes receives the key parameters to reestablish the BIB design area. The common key channels are calculated between every two nodes. The common key channels are combined to generate common keys between every two nodes.

According to a preferred embodiment of the present invention, the key parameters comprise a, b, k, r, and λ, wherein a represents a number of the keys, b represents a number of the nodes, k represents a number of the common key channels of the nodes, r represents a number that each of the keys appears at each of the nodes, and λ represents a number that each pair of the keys appears at each of the nodes.

According to a preferred embodiment of the present invention, the algorithmic parameter is r=k, or −(r−λ−k)≧1.

According to a preferred embodiment of the present invention, the step of broadcasting the key parameters from one of the nodes is from a node with a lowest identification code to broadcast the key parameters.

According to a preferred embodiment of the present invention, the step of broadcasting the key parameters from one of the nodes is from a node with a highest identification code to broadcast the key parameters.

According to a preferred embodiment of the present invention, the step of combining the common key channels comprises performing an xor operation for the common key channels.

The present invention provides another key distribution method. The method is adapted for a network. The network comprises a plurality of nodes. In the key distribution method, a plurality of keys are provided to each of the nodes, and the keys are encrypted. A plurality of blocks are provided as platforms of the nodes. An algorithmic parameter is selected, and a plurality of key parameters are provided to establish a balanced incomplete block (BIB) design area. The key parameters are broadcasted from one of the nodes. Each of the nodes receives the key parameters to reestablish the BIB design area. The common key channels are calculated between every two nodes. The common key channels are combined to generate common keys between every two nodes.

According to a preferred embodiment of the present invention, the step of combining the common key channel comprises connecting the common key channels.

In the present invention, the BIB is used to generate the common keys to reduce the transmission of the keys, to fast establish common keys, and to reduce the network band of distributing the keys. The present invention is adapted for the web link topologic environment which can be fast and dynamically established without infrastructure.

The above and other features of the present invention will be better understood from the following detailed description of the preferred embodiments of the invention that is provided in communication with the accompanying drawings.

### BRIEF DESCRIPTION OF THE DRAWINGS

FIG. 1 is a schematic drawing showing a prior art symmetric encryption system.

FIG. 2 is a schematic drawing showing a central key distribution system.

FIG. 3 is a schematic drawing showing a non-central key distribution system.

FIG. 4 is a drawing showing a prior art mobile ad hoc network. There are mobile nodes MH1-MH8.

FIG. 5 is a schematic drawing showing a key distribution within a mobile ad hoc network according to an embodiment of the present invention.

FIG. 6A is a flowchart of a key distribution method according to an embodiment of the present invention.

FIG. 6B is a flowchart of another key distribution method according to an embodiment of the present invention.

FIG. 7 is a schematic drawing showing a BIB key distribution in a mobile ad hoc network according to an embodiment of the present invention.

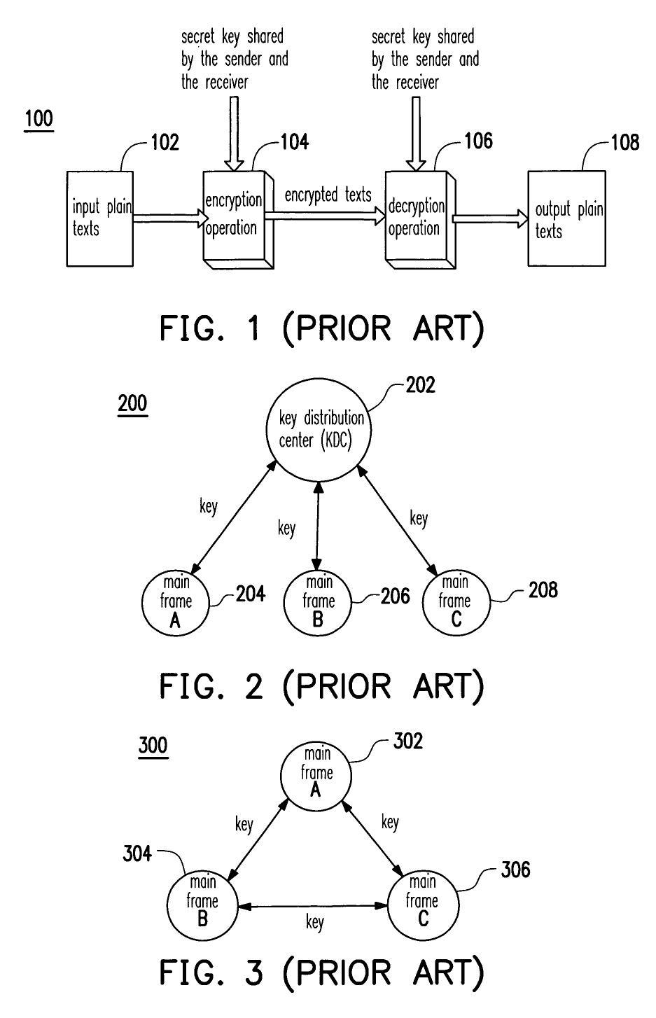

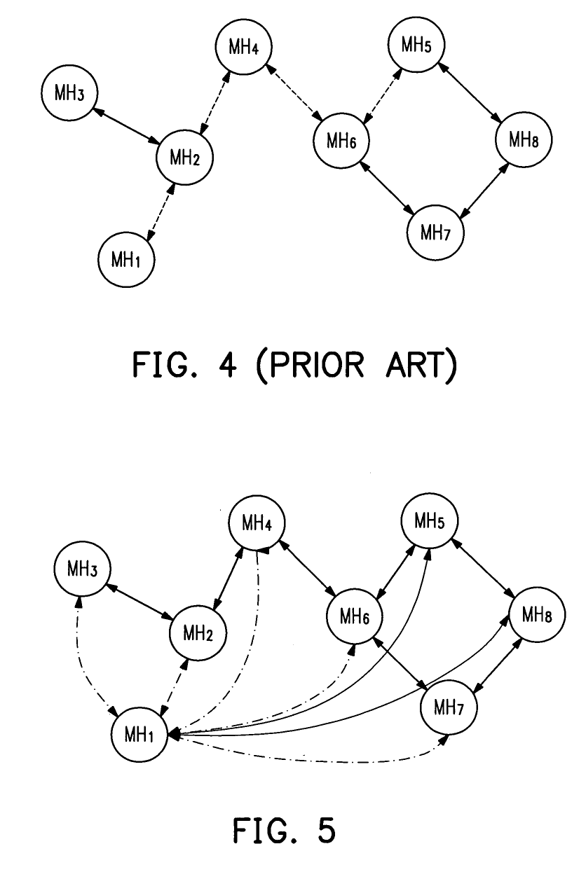

### DESCRIPTION OF SOME EMBODIMENTS

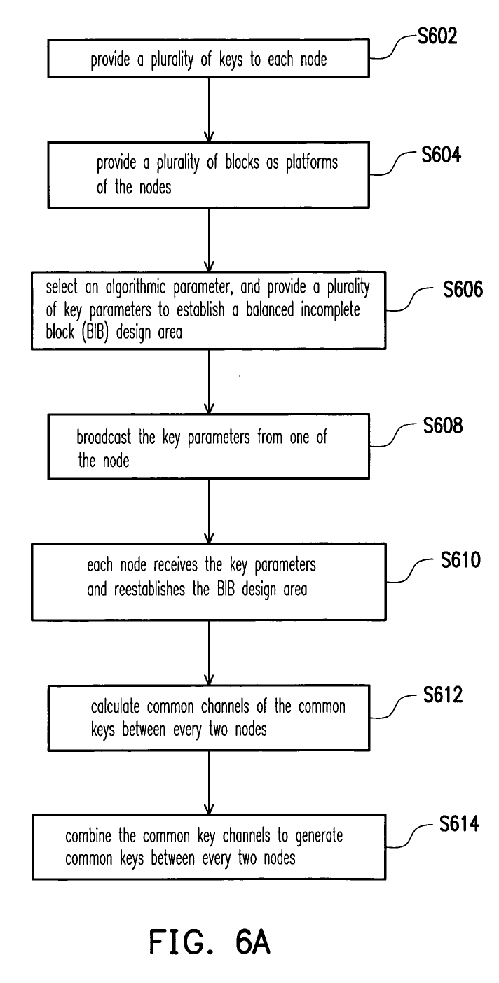

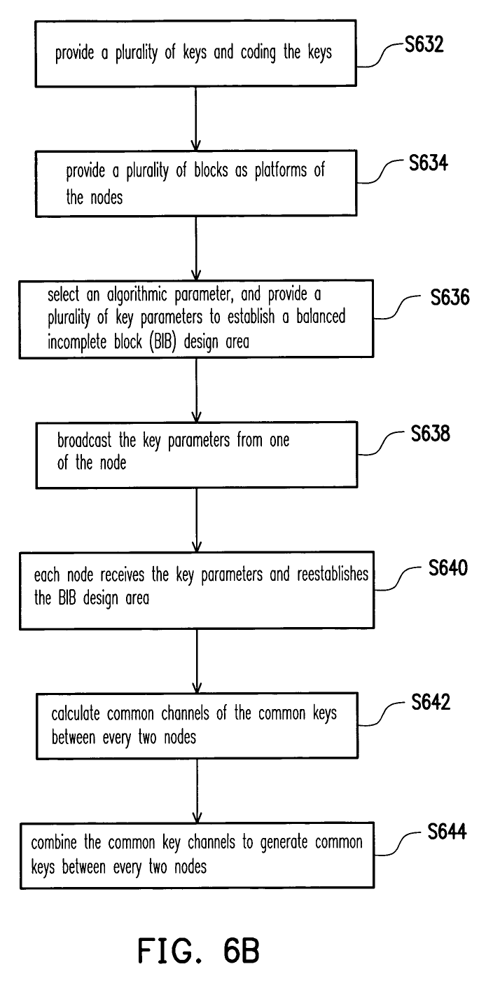

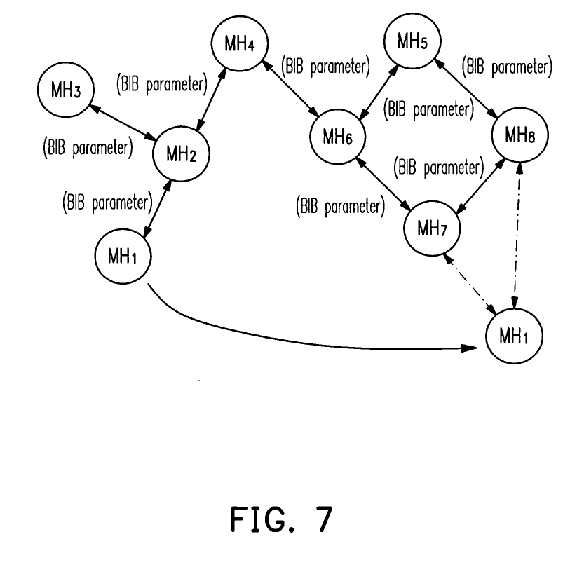

FIG. 6A is a flowchart of a key distribution method according to a preferred embodiment of the present invention. In this embodiment, the key distribution method is adapted for a network as shown in FIG. 7. The network comprises a plurality of nodes MH1-MH8. The key distribution method comprises first providing a plurality of keys to each of the nodes in the step s602. Then, a plurality of blocks are provided, serving as the platforms of the nodes in the step s604.

Wherein, the key parameters comprise a, b, k, r, and λ, wherein a represents a number of the keys, b represents a number of the nodes, k represents a number of the common key channels of the nodes, r represents a number that each of the keys appears at each of the nodes, and λ represents a number that each pair of the keys appears at each of the nodes.

An algorithmic parameter is then selected, and a plurality of key parameters are provided to establish a balanced incomplete block (BIB) design area in the step s606. Wherein, the algorithmic parameter can be, for example, r=k, or −(r−λ−k)≧1.

After the step s606, the key parameters are broadcasted from one of the nodes in the step s608. Wherein, one of ordinary skill in the art may easily understand that the key parameters can be broadcasted from the node with the lowest identification code, the node with the highest identification code, or a pre-determined node.

Each of the nodes receives the key parameters and reestablishes the BIB design area in the step s610. The common key channels between every two nodes can be computed in the step s612. Finally, the common key channels are combined to generate common keys between every two nodes in the step s614.

According to a preferred embodiment of the present invention, the common keys can be generated from the formula below.

$$- ( r - λ - k ) = {S}_{L} \leq {S}_{ij} \leq {S}_{U} = \frac{2 λ k + r ( r - λ - k )}{r} .$$

According to the inequality, if r=k, Sᵢⱼ=λ. If λ≧1, a common key exists between two blocks. The common keys serve as the key set. The same keys exist between every two nodes. If −(r−λ−k)≧1, the common keys also exist between every two nodes.

FIG. 6B is a flowchart of another key distribution method according to an embodiment of the present invention. Compared with the steps in FIG. 6A, within the steps s632-s644, the difference is that the step s632 provides a plurality of keys and the keys are with coding. The steps s634-s644 are similar to the steps s604-614. Detailed descriptions are not repeated.

According to the methods described in FIGS. 6A and 6B, the mobile ad hoc network with eight nodes can be established as shown in FIG. 7. Through the node HM1, the BIB key parameters are broadcasted to the network. After five hops, the BIB key parameters can be broadcasted to the far node MH8 and the security link of the whole network can be established. Once the node MH1 moves, communication starts.

In this embodiment, it is assumed that the network comprises four nodes Node1-4. A common key set Key1-6 are used among the nodes Node1-4. For example, the key Key1 is used between the nodes Node 1 and 2; the key Key2 is used between the nodes Node 2 and 3; the key Key3 is used between the nodes Node 3 and 4; the key Key4 is used between the nodes Node 1 and 3; the key Key5 is used between the nodes Node 1 and 4; and the key Key6 is used between the nodes Node 2 and 4. The arrangement is shown in Table 1 below. The left column represents the nodes Node 1-4, and the top row represents the keys Key 1-6.

TABLE 1

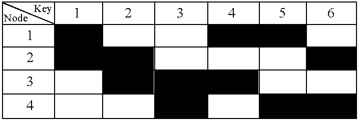

In this table, three keys appear in each node, and each key appears in two nodes. If simple parameters can be used to establish a set of common keys as shown in Table 1, network users can receive the parameters and obtain the common keys from the Table 1. Accordingly, the security link of the network can be fast established.

In this embodiment, there are four methods to establish the BIB:

Method 1: a=2fm(2fλ′−1)+1 is a prime or prime power, and b=ma,k=2fλ′,r=2fmλ′,λ=λ′.

Wherein, f,m,λ′εN, the BIB key formula of the method 1 is (f,m,λ).

Method 2: a=2fm(2fλ′+1)+1 is a prime or prime power, and b=ma,k=2fλ′+1,r=2(fmλ′+1),λ=λ′.

Wherein, f,m,λ′ εN, the BIB key formula of the method 2 is (f,m,λ).

Method 3: the limited projective plane of the sequence s, it is a prime or prime power, and a=s²+s+1=b,k=s+1=r,λ=1. The BIB key formula of the method 3 is (s).

Method 4: the affine plane of the sequence s, it is a prime or prime power, and a=s², b=s²+s, k=s, r=s+1, λ=1. With −(r−λ−k)=0, the BIB key distribution cannot be executed, i.e., no common keys.

In this embodiment, initial blocks are generated in the block formation of the Method 1 and 2. The initial blocks then shift. Accordingly, the whole block area is then established. The initial blocks of Type 1 and Type 2 are described below:

The BIB key formula of the method 1 is (f,m,λ). If f=1, m=2, and λ′=2, i.e., a=13, b=26, k=4, r=8, and A=2, the result shown in Table 2 can be obtained. Wherein, the BIB key formula of the method 2 is (f,m,λ)=(1,2,2).

TABLE 2

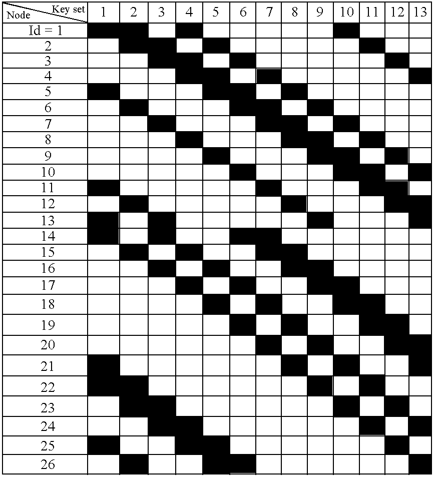

From Table 2, the mobile nodes 1 and 2 share the common key Key2; the mobile nodes 2 and 4 share the common key Key5, and the mobile nodes 6 and 7 share the common key Key7.

The BIB key formula of the method 1 is (f,m,λ). If f=1, m=1, and λ′=2, i.e., a=11, b=11, k=5, r=5, and λ=2, the result shown in Table 3 can be obtained. Wherein, the BIB key parameters is (f,m,λ)=(1,2,2).

TABLE 3

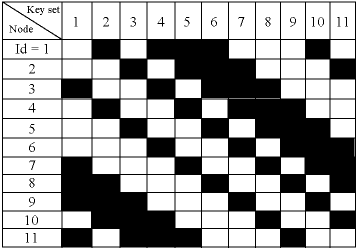

According to Table 3, the mobile nodes 1 and 2 share the common keys Key 5 and 6, the mobile nodes 2 and 4 share the common keys Key 5 and 7, and the mobile nodes 6 and 7 share the common keys Key 10 and 11.

The method 3: the BIB key parameter is (s). if s=2, i.e., a=7, b=7, k=3, r=3, and λ=1, the result shown in Table 4 can be obtained. Wherein, the BIB key parameter is s=2.

TABLE 4

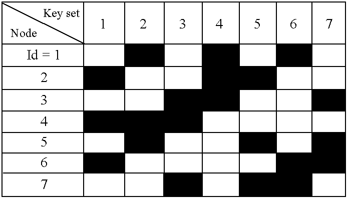

According to Table 4, the mobile nodes 1 and 2 share the common key Key4, the mobile nodes 2 and 4 share the common key Key1, and the mobile nodes 6 and 7 share the common key Key6.

Accordingly, the key distribution of the mobile ad hoc network comprises following advantages.

(1) According to the key distribution method of the mobile ad hoc network of the present invention, the number of the key transmission can be reduced from N(N−1)/2 to several hops.

(2) According to the key distribution method of the mobile ad hoc network of the present invention, the common keys can be fast established. The transmission time can be reduced from the time for N(N−1)/2 to the time for several hops.

(3) According to the key distribution method of the mobile ad hoc network of the present invention, the network bandwidth of distributing the keys can be reduced. The bandwidth can be reduced from transmitting N(N−1)/2 packets to 1 packet.

(4) According to the key distribution method of the mobile ad hoc network of the present invention, the present invention is adapted for the network topologic environment which can be fast and dynamically established without infrastructure.

(5) According to the key distribution method of the mobile ad hoc network of the present invention, it can be used in the mobile ad hoc network or wired network systems. The mobile ad hoc network can be used in military, such as the wireless communication systems among digital warriors, field combat wireless communication systems, ship-to-ship wireless communication systems, or joint combat wireless communication systems. In addition, it also can be used in the public, such as the communication systems of police, the communication systems of fire fighters, the communication systems for emergency, or car-to-car communication systems for highways.

(6) According to the key distribution method of the mobile ad hoc network of the present invention, it can cooperate with military wireless systems so as to be used in the communication systems with different frequency bands of military. In addition, it may be integrated with an 802.11 wireless card to extend its wireless communication scope and to be used by outdoor mobile users.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A key distribution method, adapted for a network, the network comprising a plurality of nodes, the key distribution method comprising:
providing a plurality of keys to each of the nodes;
providing a plurality of blocks as platforms of the nodes;
selecting an algorithmic parameter, and providing a plurality of key parameters to establish a balanced incomplete block (BIB) design area;
broadcasting the key parameters from one of the nodes;
receiving from the key parameters by each of the nodes to reestablish the BIB design area;
calculating common key channels between every two nodes; and
combining the common key channels to generate common keys between every two nodes.

2. The key distribution method of claim 1, wherein the key parameters comprise a, b, k, r, and λ, wherein a represents a number of the keys, b represents a number of the nodes, k represents a number of the common key channels of the nodes, r represents a number that each of the keys appears at each of the nodes, and λ represents a number that each pair of the keys appears at each of the nodes.

3. The key distribution method of claim 2, wherein the algorithmic parameter is r=k.

4. The key distribution method of claim 2, wherein the algorithmic parameter is −(r−λ−k)≧1.

5. The key distribution method of claim 1, wherein the step of broadcasting the key parameters from one of the nodes is from a node with a lowest identification code to broadcast the key parameters.

6. The key distribution method of claim 1, wherein the step of broadcasting the key parameters from one of the nodes is from a node with a highest identification code to broadcast the key parameters.

7. The key distribution method of claim 1, wherein the step of combining the common key channels comprises performing an xor operation for the common key channels.

8. A key distribution method, adapted for a network, the network comprising a plurality of nodes, the key distribution method comprising:
providing a plurality of keys, and coding the keys;
providing a plurality of blocks as platforms of the nodes;
selecting an algorithmic parameter, and providing a plurality of key parameters to establish a balanced incomplete block (BIB) design area;
broadcasting the key parameters from one of the nodes;
receiving from the key parameters by each of the nodes to reestablish the BIB design area;
calculating common key channels between every two nodes; and
combining the common key channels to generate common keys between every two nodes.

9. The key distribution method of claim 8, wherein the key parameters comprise a, b, k, r, and λ, wherein a represents a number of the keys, b represents a number of the nodes, k represents a number of the common key channels of the nodes, r represents a number that each of the keys appears at each of the nodes, and λ represents a number that each pair of the keys appears at each of the nodes.

10. The key distribution method of claim 9, wherein the algorithmic parameter is r=k.

11. The key distribution method of claim 9, wherein the algorithmic parameter is −(r−/λ−k)≧1.

12. The key distribution method of claim 8, wherein the step of broadcasting the key parameters from one of the nodes is from a node with a lowest identification code to broadcast the key parameters.

13. The key distribution method of claim 8, wherein the step of broadcasting the key parameters from one of the nodes is from a node with a highest identification code to broadcast the key parameters.

14. The key distribution method of claim 8, wherein the step of combining the common key channels comprises performing an xor operation for the common key channels.
